(19) United States
(12) Patent Application Publication
(10) Pub. No.: US 2024/0320435 A1
(43) Pub. Date: Sep. 26, 2024

(54) METHOD AND APPARATUS FOR ENTITY RELATIONSHIP RECOGNITION, ELECTRONIC DEVICE, AND STORAGE MEDIUM

(71) Applicant: Beijing Hydrophis Network Technology Co., Ltd., Beijing (CN)

(72) Inventors: Feng Hong, Beijing (CN); Min Huang, Beijing (CN); Weijie Zhou, Beijing (CN); Shanliang Xiong, Beijing (CN); Wenbi Cai, Beijing (CN); Youpeng Wei, Beijing (CN)

(21) Appl. No.: 18/600,761

(22) Filed: Mar. 10, 2024

(30) Foreign Application Priority Data
Mar. 23, 2023 (CN) 202310302935.4

(51) Int. Cl. G06F 40/295; G06F 40/166

(52) U.S. Cl. CPC G06F 40/295; G06F 40/166

(57) ABSTRACT

The present invention relates to a data analysis technology and discloses a method for entity relationship recognition. The method for entity relationship recognition includes: performing sentence segmentation on a to-be-recognized text to obtain a statement text; performing entity recognition on the statement text, and screening all statement texts to obtain a target statement text; performing text fuzzing on the target statement text to obtain a to-be-recognized fuzzy text; acquiring all optional entity relationships and an example sentence text corresponding to each of the optional entity relationships, and likewise performing text fuzzing on the example sentence text to obtain a corresponding example sentence fuzzy text; and screening the example fuzzy text similar to the target statement text, and determining the optional entity relationship corresponding to the screened example sentence text as an entity relationship recognition result. The present invention can improve the efficiency of entity relationship recognition.

### CROSS REFERENCE TO RELATED APPLICATIONS

The present application claims the benefit of Chinese Patent Application No. 202310302935.4 filed on Mar. 23, 2023, the contents of which are incorporated herein by reference in their entirety.

### TECHNICAL FIELD

The present invention relates to a data analysis technology, in particular to a method and apparatus for entity relationship recognition, an electronic device, and a storage medium.

### BACKGROUND

The main task of naming entity recognition is to recognize proper names such as personal names and place names as well as meaningful quantity phrases such as time and dates in a text and make classification. A relationship existing between named entities is an entity relationship. Entity relationship extraction is an important task in text information extraction, which is of great significance to research and application of an information extraction technology.

At present, naming an entity relationship requests the recognition of all entity relationships in a to-be-recognized text. The entity relationship recognition is low in efficiency.

### SUMMARY

The present invention provides a method and apparatus for entity relationship recognition, an electronic device and a storage medium and mainly intends to improve the efficiency of entity relationship recognition.

The method includes: acquiring a to-be-recognized text and target entity types requiring entity relationship recognition, performing sentence segmentation on the to-be-recognized text to obtain one or more statement texts;
performing entity recognition on the statement text, and performing entity type screening on all statement texts based on an entity recognition result and the target entity types to obtain a target statement text;
replacing entities corresponding to the target entity types in the target statement text with a predetermined identifier, performing part-of-speech tagging and acceptation or rejection on the replaced target statement text to obtain a to-be-recognized fuzzy text;
acquiring all optional entity relationships among the entities of the target entity types and an entity relationship example sentence text corresponding to each of the optional entity relationships, replacing the entities of the target entity types in the entity relationship example sentence text with the predetermined identifier, performing part-of-speech tagging and acceptation or rejection on the replaced entity relationship example sentence text to obtain a corresponding example sentence fuzzy text;
calculating a similarity between the to-be-recognized fuzzy text and the example sentence fuzzy text to obtain a text similarity; and
screening all entity relationship example sentences based on the text similarity, and determining the optional entity relationship corresponding to the screened entity relationship example sentence as an entity relationship recognition result of the to-be-recognized text.

Optionally, the performing sentence segmentation on the to-be-recognized text to obtain one or more statement texts includes:
replacing all statement identifiers of preset types contained in the to-be-recognized text with a preset segmentation symbol to obtain an initial to-be-segmented text;
adding the segmentation symbol before a first character of the initial to-be-segmented text to obtain a target to-be-segmented text; and
segmenting all characters between every two adjacent segmentation symbols in the target to-be-segmented text to obtain the statement text.

Optionally, the performing sentence segmentation on the to-be-recognized text to obtain one or more statement texts includes:
judging whether a quantity of the statement identifier of a preset type contained in the to-be-recognized text is larger than 1;

when the quantity of the statement identifier of a preset type contained in the to-be-recognized text is larger than 1, replacing all statement identifiers of preset types contained in the to-be-recognized text with a preset segmentation symbol to obtain an initial to-be-segmented text;
adding the segmentation symbol before a first character of the initial to-be-segmented text to obtain a target to-be-segmented text;
segmenting all characters between every two adjacent segmentation symbols in the target to-be-segmented text to obtain the statement text; and
when the quantity of the statement identifier of a preset type contained in the to-be-recognized text is smaller than or equal to 1, determining the to-be-recognized text as the statement text.

Optionally, the performing entity recognition on the statement text, and the performing entity type screening on all statement texts based on an entity recognition result and the target entity types to obtain a target statement text include:
recognizing entity types of all entities in the statement text; and
determining the statement text containing all the target entity types in all the recognized entity types as the target statement text.

Optionally, the replacing entities corresponding to the target entity types in the target statement text with a predetermined identifier, and the performing part-of-speech tagging and acceptation or rejection on the replaced target statement text to obtain a to-be-recognized fuzzy text include:
determining the entities corresponding to the target entity types in the target statement text as target words, and labeling the entity types of the entities in the target statement text;
determining a sentence trunk in the target statement text according to a dependency grammar tag, performing a grammar back-tracing operation on the target words not contained in the sentence trunk till determining that the target words are connected to a layer-by-layer correlation chain of the sentence trunk, and replacing a word not in the layer-by-layer correlation chain with a preset substitution identifier to obtain a first fuzzy text containing the sentence trunk;
replacing the target word in the first fuzzy text with a predetermined identifier to obtain a second fuzzy text;
reserving only the entity type of an entity of a non-target word in the second fuzzy text to obtain a third fuzzy text; and
reserving a non-entity word of a preset part-of-speech type in the third fuzzy text and corresponding part-of-speech information, and reserving part-of-speech information of the non-entity word of a non-preset type in the third fuzzy text to obtain the to-be-recognized fuzzy text.

Optionally, calculating a similarity between the to-be-recognized fuzzy text and the example sentence fuzzy text to obtain a text similarity includes:
transforming the to-be-recognized fuzzy text to a to-be-recognized fuzzy text vector, and transforming the example sentence fuzzy text to an example sentence fuzzy text vector; and
calculating a vector similarity between the to-be-recognized fuzzy text vector and the example sentence fuzzy text vector to obtain the text similarity.

Optionally, screening all entity relationship example sentences based on the text similarity, and determining the optional entity relationship corresponding to the screened entity relationship example sentence as an entity relationship recognition result of the to-be-recognized text include:
determining the example sentence fuzzy text corresponding to an example sentence fuzzy text vector corresponding to a maximum text similarity as the target example sentence fuzzy text;
determining the entity relationship example sentence corresponding to the target example sentence fuzzy text as the target entity relationship example sentence;
determining the optional entity relationship corresponding to the target entity relationship example sentence as the entity relationship recognition result in the target statement text; and
summarizing all entity relationship recognition results in the target statement text to obtain the entity relationship recognition result of the to-be-recognized text.

In order to solve the above problems, the present invention further provides an apparatus for entity relationship recognition, wherein the apparatus includes:
a text segmentation and screening module, configured for acquiring a to-be-recognized text and target entity types requiring entity relationship recognition, performing sentence segmentation on the to-be-recognized text to obtain one or more statement texts; and performing entity recognition on the statement text, and performing entity type screening on all statement texts based on an entity recognition result and the target entity types to obtain a target statement text;
a statement fuzzing module, configured for replacing entities corresponding to the target entity types in the target statement text with a predetermined identifier, performing part-of-speech tagging and acceptation or rejection on the replaced target statement text to obtain a to-be-recognized fuzzy text; acquiring all optional entity relationships among the entities of the target entity types and an entity relationship example sentence text corresponding to each of the optional entity relationships, replacing the entities of the target entity types in the entity relationship example sentence text with the predetermined identifier, performing part-of-speech tagging and acceptation or rejection on the replaced entity relationship example sentence text to obtain a corresponding example sentence fuzzy text; and
an entity relationship recognition module, configured for calculating a similarity between the to-be-recognized fuzzy text and the example sentence fuzzy text to obtain a text similarity; and screening all entity relationship example sentences based on the text similarity, and determining the optional entity relationship corresponding to the screened entity relationship example sentence as an entity relationship recognition result of the to-be-recognized text.

In order to solve the above problems, the present invention further provides an electronic device, wherein the electronic device includes:
a memory that stores at least one computer program; and
a processor that executes the computer program stored in the memory to implement the above method for entity relationship recognition.

In order to solve the above problems, the present invention further provides a computer readable storage medium, wherein the computer readable storage medium stores at least one computer program, and the at least one computer program is executed by the processor in the electronic device to implement the above method for entity relationship recognition.

Embodiments of the present invention include: performing entity recognition on the statement text, and performing entity type screening on all statement texts based on an entity recognition result and the target entity types to obtain a target statement text; replacing entities corresponding to the target entity types in the target statement text with a predetermined identifier, performing part-of-speech tagging and acceptation or rejection on the replaced target statement text to obtain a to-be-recognized fuzzy text; acquiring all optional entity relationships among the entities of the target entity types and an entity relationship example sentence text corresponding to each of the optional entity relationships, replacing the entities of the target entity types in the entity relationship example sentence text with the predetermined identifier, performing part-of-speech tagging and acceptation or rejection on the replaced entity relationship example sentence text to obtain a corresponding example sentence fuzzy text; calculating a similarity between the to-be-recognized fuzzy text and the example sentence fuzzy text to obtain a text similarity; screening all entity relationship example sentences based on the text similarity, and determining the optional entity relationship corresponding to the screened entity relationship example sentence as an entity relationship recognition result of the to-be-recognized text. Compared with recognition of all the entity relationships in the to-be-recognized text, the relationships among the entities of the specific type are recognized, so invalid recognition is reduced; and the efficiency of entity relationship recognition is increased. Therefore, the method and apparatus for entity relationship recognition, the electronic device and the readable storage medium proposed by the embodiments of the present invention increase the efficiency of entity relationship recognition.

### BRIEF DESCRIPTION OF THE ACCOMPANYING DRAWINGS

FIG. 1 is a schematic flow diagram of a method for entity relationship recognition provided by an embodiment of the present invention;

FIG. 2 is a schematic module diagram of an apparatus for entity relationship recognition provided by an embodiment of the present invention;

FIG. 3 is a schematic diagram of an internal structure of an electronic device for implementing a method for entity relationship recognition provided by an embodiment of the present invention; and

Purpose realization, function characteristics and advantages of the present invention will be further described with reference to drawings in conjunction with the embodiments.

### DETAILED DESCRIPTION OF ILLUSTRATED EMBODIMENTS

It should be understood that specific embodiments described here are only to explain the present invention, not to limit the present invention.

An embodiment of the invention provides a method for entity relationship recognition. An execution subject of the method for entity relationship recognition includes, but is not limited to, at least one of the electronic devices such as servers and terminals that may be configured to execute the method provided by the embodiment of the present application. In other words, the method for entity relationship recognition may be executed by software or hardware installed in a terminal device or a server device, and the software may be a blockchain platform. The server includes, but is not limited to, a single server, a server cluster, a cloud server or a cloud server cluster, etc. The server may be an independent server or a cloud server providing basic cloud computing services such as a cloud service, a cloud database, cloud computing, a cloud function, cloud storage, a network service, cloud communication, a middleware service, a domain name service, a security service, a Content Delivery Network (CDN), Big Data and an artificial intelligence platform.

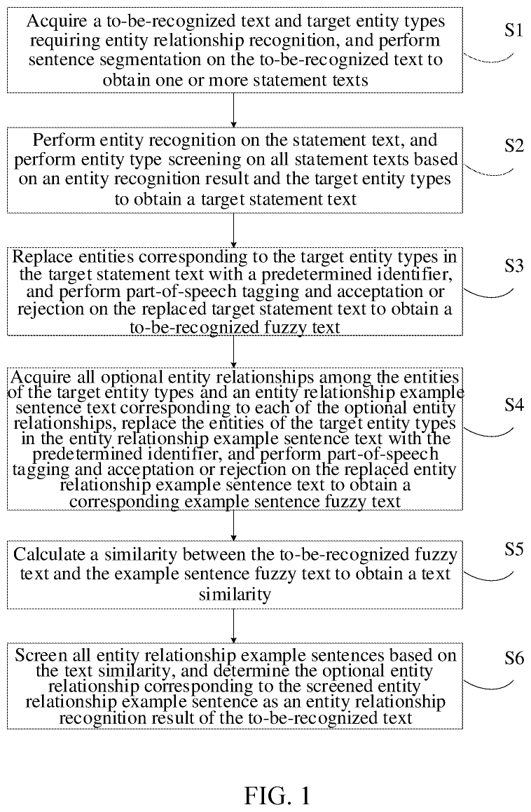

Referring to a flow diagram of a method for entity relationship recognition provided by an embodiment of the present invention shown in FIG. 1, in the embodiment of the present invention, the method for entity relationship recognition includes the following steps:

S1: acquiring a to-be-recognized text and target entity types requiring entity relationship recognition, and performing sentence segmentation on the to-be-recognized text to obtain one or more statement texts.

In the embodiment of the present invention, the to-be-recognized text may be a historical work experience information text of company employees. A target instance type is an entity type corresponding to an entity pair requiring entity relationship recognition. For example, if a relationship between an employee and a company is to be recognized, target entity types include a personal name and a company name.

Further, in order to improve the recognition efficiency of entity relationships in the to-be-recognized text, the embodiment of the present invention segments the to-be-recognized text sentence by sentence to obtain a plurality of statement texts.

Specifically, in the embodiment of the present invention, the performing sentence segmentation on the to-be-recognized text to obtain one or more statement texts includes:
replacing all statement identifiers of preset types contained in the to-be-recognized text with a preset segmentation symbol to obtain an initial to-be-segmented text;
adding the segmentation symbol before a first character of the initial to-be-segmented text to obtain a target to-be-segmented text; and
segmenting all characters between every two adjacent segmentation symbols in the target to-be-segmented text to obtain the statement text.

Further, in another embodiment of the present invention, in order to improve segmentation efficiency, segmentation is not needed when there is only one sentence in the to-be-recognized text. Therefore, the performing sentence segmentation on the to-be-recognized text to obtain one or more statement texts includes:
judging whether a quantity of the statement identifier of a preset type contained in the to-be-recognized text is larger than 1;
when the quantity of the statement identifier of a preset type contained in the to-be-recognized text is larger than 1, replacing all statement identifiers of preset types contained in the to-be-recognized text with a preset segmentation symbol to obtain an initial to-be-segmented text;
adding the segmentation symbol before a first character of the initial to-be-segmented text to obtain a target to-be-segmented text;
segmenting all characters between every two adjacent segmentation symbols in the target to-be-segmented text to obtain the statement text; and

when the quantity of the statement identifier of a preset type contained in the to-be-recognized text is smaller than or equal to 1, determining the to-be-recognized text as the statement text.

S2: performing entity recognition on the statement text, and performing entity type screening on all statement texts based on an entity recognition result and the target entity types to obtain a target statement text.

In the embodiment of the present invention, the recognized statement text needs to contain entities of at least two target entity types. Hence, in order to screen the statement text satisfying conditions, the embodiment of the present invention includes: performing entity recognition on the statement text, and performing entity type screening on all statement texts based on an entity recognition result and the target entity types to obtain a target statement text.

In detail, the S2 in the embodiment of the present invention includes:
recognizing entity types of all entities in the statement text; and
determining the statement text containing all the target entity types in all the recognized entity types as the target statement text.

S3: replacing entities corresponding to the target entity types in the target statement text with a predetermined identifier, and performing part-of-speech tagging and acceptation or rejection on the replaced target statement text to obtain a to-be-recognized fuzzy text.

Because the main structural characteristics of sentences of two entities with the same entity relationship are very similar, in order to obtain the structural characteristics of the target statement text, the embodiment of the invention removes personalized information in the target statement text and reserves the statement main structural information. Hence, entities corresponding to the target entity types in the target statement text are replaced with a predetermined identifier, and part-of-speech tagging and acceptation or rejection are performed on the replaced target statement text to obtain a to-be-recognized fuzzy text. The part-of-speech tagging and acceptation or rejection refers to deleting and reserving texts in a target statement according to parts of speech of words, so as to further remove the personalized information in the target statement text and achieve the purpose of reserving the main structure information of the statement. In detail, S3 in the embodiment of the present invention includes:
determining the entities corresponding to the target entity types in the target statement text as target words, and labeling the entity types of the entities in the target statement text;
determining a sentence trunk in the target statement text according to a dependency grammar tag, performing a grammar back-tracing operation on the target words not contained in the sentence trunk till determining that the target words are connected to a layer-by-layer correlation chain of the sentence trunk, and replacing a word not in the layer-by-layer correlation chain with a preset substitution identifier to obtain a first fuzzy text containing the sentence trunk;
replacing the target word in the first fuzzy text with a predetermined identifier to obtain a second fuzzy text;
reserving only the entity type of an entity of a non-target word in the second fuzzy text to obtain a third fuzzy text; and
reserving a non-entity word of a preset part-of-speech type in the third fuzzy text and corresponding part-of-speech information, and reserving part-of-speech information of non-entity words of a non-preset type in the third fuzzy text to obtain the to-be-recognized fuzzy text.

For example: the target statement is that Li XX is an employee of Company A; the target words are Li XX and Company A; a predetermined identifier is [T], and a preset substitution identifier is *, then a to-be-recognized text obtained after processing is that [T]/nh is/v [T]/cn*employee/n. Specifically, the preset part-of-speech types include, but are not limited to, adjectives, nouns, and verbs.

S4: acquiring all optional entity relationships among the entities of the target entity types and an entity relationship example sentence text corresponding to each of the optional entity relationships, replacing the entities of the target entity types in the entity relationship example sentence text with the predetermined identifier, and performing part-of-speech tagging and acceptation or rejection on the replaced entity relationship example sentence text to obtain a corresponding example sentence fuzzy text.

In the embodiment of the present invention, the entity relationship example sentence text contains entities of two target entity types, and the relationship between the two entities is a sentence text example of an optional entity relationship.

In the embodiment of the present invention, a specific implementation method for replacing the entities of the target entity types in the entity relationship example sentence text with the predetermined identifier, performing part-of-speech tagging and acceptation or rejection on the replaced entity relationship example sentence text to obtain a corresponding example sentence fuzzy text is similar with S3, which is not repeated here.

S5: calculating a similarity between the to-be-recognized fuzzy text and the example sentence fuzzy text to obtain a text similarity.

In the embodiment of the present invention, the calculating a similarity between the to-be-recognized fuzzy text and the example sentence fuzzy text to obtain a text similarity includes:
transforming the to-be-recognized fuzzy text to a to-be-recognized fuzzy text vector, and transforming the example sentence fuzzy text to an example sentence fuzzy text vector; and
calculating a vector similarity between the to-be-recognized fuzzy text vector and the example sentence fuzzy text vector to obtain the text similarity.

In detail, the transforming the to-be-recognized fuzzy text to a vector to obtain a to-be-recognized fuzzy text vector in the embodiment of the present invention includes:
transforming each character in the to-be-recognized fuzzy text to a vector to obtain a corresponding character vector;
combining all the character vectors according to a position order of the corresponding characters in the to-be-recognized fuzzy text to obtain a fuzzy text matrix; and
performing feature dimension compression of the fuzzy text matrix to obtain the to-be-recognized fuzzy text vector.

Further, in the embodiment of the present invention, the method for transforming the example sentence fuzzy text to the example sentence fuzzy text vector is similar to the method of transforming the to-be-recognized fuzzy text to the to-be-recognized fuzzy text vector, which is not repeated here.

Further, in the embodiment of the present invention, algorithms such as a Euclidean distance and a cosine similarity may be used to calculate the vector similarity between the to-be-recognized fuzzy text vector and the example sentence fuzzy text vector, and the embodiment of the present invention does not limit the calculation method of the vector similarity.

S6: screening all entity relationship example sentences based on the text similarity, and determining the optional entity relationship corresponding to the screened entity relationship example sentence as an entity relationship recognition result of the to-be-recognized text.

In order to screen the most consistent entity relationship example sentence and improve the accuracy of entity relationship recognition, in the embodiment of the present invention, all entity relationship example sentences are screened based on the text similarity; and the optional entity relationship corresponding to the screened entity relationship example sentence is determined as an entity relationship recognition result in the target statement text.

In detail, S6 in the embodiment of the present invention includes:
determining the example sentence fuzzy text corresponding to an example sentence fuzzy text vector corresponding to a maximum text similarity as the target example sentence fuzzy text;
determining the entity relationship example sentence corresponding to the target example sentence fuzzy text as the target entity relationship example sentence;
determining the optional entity relationship corresponding to the target entity relationship example sentence as the entity relationship recognition result in the target statement text; and
summarizing all entity relationship recognition results in the target statement text to obtain the entity relationship recognition result of the to-be-recognized text.

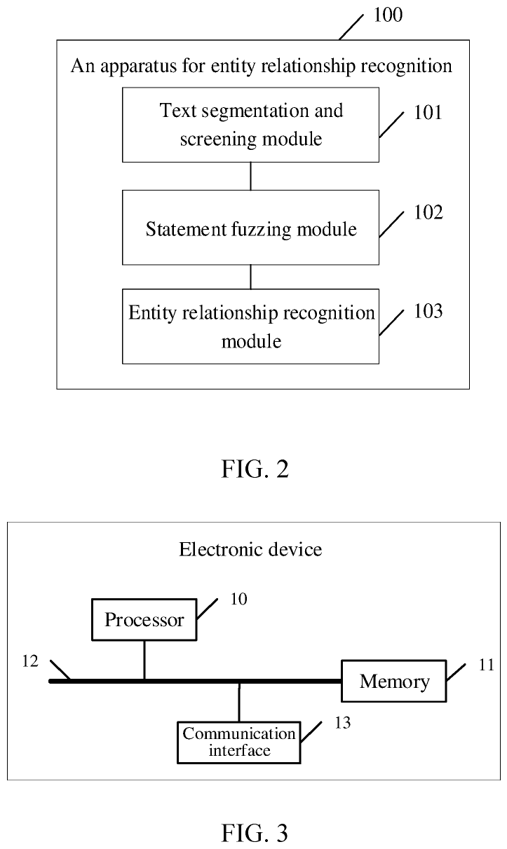

As shown in FIG. 2, it is a functional module diagram of an apparatus for entity relationship recognition of the present invention.

The apparatus for entity relationship recognition 100 in the present invention may be installed in an electronic device. Depending on the function implemented, the apparatus for entity relationship recognition may include a text segmentation and screening module 101, a statement fuzzing module 102, and an entity relationship recognition module 103. The module in the present invention may also be called a unit. The unit refers to a series of computer program segments that can be executed by a processor of the electronic device and can complete fixed functions, which are stored in the memory of the electronic device.

In the present embodiment, the functions of each module/unit are as follows.

The text segmentation and screening module 101 is configured for acquiring a to-be-recognized text and target entity types requiring entity relationship recognition, performing sentence segmentation on the to-be-recognized text to obtain one or more statement texts; and performing entity recognition on the statement text, and performing entity type screening on all statement texts based on an entity recognition result and the target entity types to obtain a target statement text;
the statement fuzzing module 102 is configured for replacing entities corresponding to the target entity types in the target statement text with a predetermined identifier, performing part-of-speech tagging and acceptation or rejection on the replaced target statement text to obtain a to-be-recognized fuzzy text; acquiring all optional entity relationships among the entities of the target entity types and an entity relationship example sentence text corresponding to each of the optional entity relationships, replacing the entities of the target entity types in the entity relationship example sentence text with the predetermined identifier, and performing part-of-speech tagging and acceptation or rejection on the replaced entity relationship example sentence text to obtain a corresponding example sentence fuzzy text; and
the entity relationship recognition module 103 is configured for calculating a similarity between the to-be-recognized fuzzy text and the example sentence fuzzy text to obtain a text similarity; screening all entity relationship example sentences based on the text similarity, and determining the optional entity relationship corresponding to the screened entity relationship example sentence as an entity relationship recognition result of the to-be-recognized text.

In detail, each module described in the apparatus for entity relationship recognition 100 in the embodiment of the present invention adopts the same technical means as the method for entity relationship recognition described in FIG. 1, and can produce the same technical effects, which will not be repeated here.

As shown in FIG. 3, it is a schematic structural diagram of an electronic device for realizing a method for entity relationship recognition according to the present invention.

The electronic device may include a processor 10, a memory 11, a communication bus 12 and a communication interface 13, and may also include a computer program stored in the memory 11 and running on the processor 10, such as an entity relationship recognition program.

Specifically, the memory 11 includes at least one type of readable storage medium, including a flash memory, a mobile hard disk, a multimedia card, a card memory (such as SD or DX memory), a magnetic memory, a magnetic disk, an optical disk, etc. In some embodiments, the memory 11 may be an internal storage unit of an electronic device, such as a mobile hard disk of the electronic device. In other embodiments, the memory 11 may also be an external storage device of an electronic device, such as a plug-in mobile hard disk, a Smart Media Card (SMC), a Secure Digital (SD) card, a Flash Card, etc. mounted on the electronic device. Further, the memory 11 may also include both an internal storage unit of the electronic device and an external storage device. The memory 11 can be configured not only for storing application software and various data installed in the electronic device, such as a code of an entity relationship recognition program, but also for temporarily storing data that has been or will be output.

In some embodiments, the processor 10 may be composed of integrated circuits, for example, a single packaged integrated circuit, or a plurality of integrated circuits packaged with the same function or different functions, including one or more Central Processing Unit (CPU), microprocessors, digital processing chips, graphics processors, combinations of various control chips, etc. The processor 10 is a Control Unit of the electronic device, which connects all components of the electronic device with various interfaces and lines, and executes various functions and processes data of the electronic device by running or executing programs or modules (such as entity relationship recognition programs) stored in the memory 11 and calling data stored in the memory 11.

The communication bus 12 may be a Peripheral Component Interconnect (PCI) bus or an Extended Industry Standard Architecture (EISA) bus. The bus may be divided into an address bus, a data bus and a control bus. The communication bus 12 is set to realize connection communication between the memory 11 and at least one processor 10, etc. For the convenience of representation, the bus is only represented by a thick line in the diagram, but it does not mean that there is only one bus or one type of bus.

FIG. 3 only shows the electronic device with components. Those skilled in the art can understand that the structure shown in FIG. 3 does not constitute a limitation on the electronic device, and may include fewer or more components than shown, or combine some components, or have different component arrangements.

For example, although not shown, the electronic device may further include a power supply (such as a battery) for supplying power to various components. Preferably, the power supply may be logically connected with the at least one processor 10 through a power management device, so that functions such as charging management, discharging management, and power consumption management can be realized through the power management device. The power supply can also include one or more DC or AC power supplies, recharging devices, power failure classification circuits, power converters or inverters, power status indicators and other arbitrary components. The electronic device may also include various sensors, Bluetooth modules, Wi-Fi modules, etc., which will not be repeated here.

Optionally, the communication interface 13 may include a wired interface and/or a wireless interface (such as a WI-FI interface, a Bluetooth interface, etc.), and is usually configured to establish a communication connection between the electronic device and other electronic devices.

Optionally, the communication interface 13 may also include a user interface, which may be a Display, an input unit (such as a Keyboard), and optionally, a standard wired interface or a wireless interface. Optionally, in some embodiments, the display may be an LED display, a liquid crystal display, a touch liquid crystal display, an OLED (Organic Light-Emitting Diode) touch device, etc. Specifically, the display can also be appropriately called a display screen or a display unit, that is configured for displaying information processed in the electronic device and a visual user interface.

It should be understood that the embodiment is only for illustration, and the scope of patent application is not limited by this structure.

An entity relationship recognition program stored in the memory 11 in the electronic device is a combination of a plurality of computer programs, and when running in the processor 10, the program can implement:
acquiring a to-be-recognized text and target entity types requiring entity relationship recognition, performing sentence segmentation on the to-be-recognized text to obtain one or more statement texts;
performing entity recognition on the statement text, and performing entity type screening on all statement texts based on an entity recognition result and the target entity types to obtain a target statement text;
replacing entities corresponding to the target entity types in the target statement text with a predetermined identifier, performing part-of-speech tagging and acceptation or rejection on the replaced target statement text to obtain a to-be-recognized fuzzy text;
acquiring all optional entity relationships among the entities of the target entity types and an entity relationship example sentence text corresponding to each of the optional entity relationships, replacing the entities of the target entity types in the entity relationship example sentence text with the predetermined identifier, performing part-of-speech tagging and acceptation or rejection on the replaced entity relationship example sentence text to obtain a corresponding example sentence fuzzy text;
calculating a similarity between the to-be-recognized fuzzy text and the example sentence fuzzy text to obtain a text similarity; and
screening all entity relationship example sentences based on the text similarity, and determining the optional entity relationship corresponding to the screened entity relationship example sentence as an entity relationship recognition result of the to-be-recognized text.

Specifically, a specific implementation method of the above computer program by the processor 10 can refer to the description of relevant steps in the corresponding embodiment in FIG. 1, which will not be repeated here.

Further, the integrated module/unit of the electronic device may be stored in a computer readable storage medium if it is realized in the form of a software functional unit and sold or used as an independent product. The computer readable medium may be non-volatile or volatile. The computer readable medium may include any entity or device capable of carrying the computer program code, a recording medium, a U disk, a mobile hard disk, a magnetic disk, an optical disk, a computer memory and a Read-Only Memory (ROM).

Embodiments of the present invention may further provide a computer readable storage medium storing a computer program, which, when executed by a processor of an electronic device, can implement:
acquiring a to-be-recognized text and target entity types requiring entity relationship recognition, performing sentence segmentation on the to-be-recognized text to obtain one or more statement texts;
performing entity recognition on the statement text, and performing entity type screening on all statement texts based on an entity recognition result and the target entity types to obtain a target statement text;
replacing entities corresponding to the target entity types in the target statement text with a predetermined identifier, performing part-of-speech tagging and acceptation or rejection on the replaced target statement text to obtain a to-be-recognized fuzzy text;
acquiring all optional entity relationships among the entities of the target entity types and an entity relationship example sentence text corresponding to each of the optional entity relationships, replacing the entities of the target entity types in the entity relationship example sentence text with the predetermined identifier, performing part-of-speech tagging and acceptation or rejection on the replaced entity relationship example sentence text to obtain a corresponding example sentence fuzzy text;
calculating a similarity between the to-be-recognized fuzzy text and the example sentence fuzzy text to obtain a text similarity; and
screening all entity relationship example sentences based on the text similarity, and determining the optional entity relationship corresponding to the screened entity relationship example sentence as an entity relationship recognition result of the to-be-recognized text.

Further, the computer readable storage medium may mainly include a storage program area and a storage data area, wherein the storage program area may store an operating system, an application program required by at least one function, and the like; the storage data area may store data created according to the use of blockchain nodes, etc.

In several embodiments provided by the present invention, it should be understood that the disclosed device, apparatus and method may be realized in other ways. For example, the device embodiment described above is only schematic. For example, the division of the module is only a logical function division, and there may be another division method in actual implementation.

The modules described as separate components may or may not be physically separated, and the components displayed as modules may or may not be physical units. In other words, the modules may be located in one place or distributed to multiple network units. Some or all of the modules may be selected according to actual needs to achieve the purpose of a scheme of the present embodiment.

The embodiment of the invention can acquire and process related data based on artificial intelligence technology. Specifically, Artificial Intelligence (AI) is a theory, method, technology and application system that uses digital computers or machines controlled by digital computers to simulate, extend and expand human intelligence, perceive the environment, acquire knowledge and use knowledge to obtain the best results.

In addition, each functional module in each embodiment of the present invention may be integrated into one processing unit, or each unit may exist physically alone, or two or more units may be integrated into one unit. The above integrated units may be realized in the form of hardware, or in the form of hardware plus software functional modules.

It is apparent to those skilled in the art that the present invention is not limited to the details of the above exemplary embodiments, but may be realized in other specific forms without departing from the spirit or essential characteristics of the present invention.

Therefore, the embodiments should be considered in all aspects as illustrative and not restrictive, and the scope of the invention is defined by the appended claims rather than the above description, so it is intended to embrace all changes that fall within the meaning and range of equivalents of the claims. Any accompanying drawing mark in the claims should not be regarded as limiting the related claims.

The blockchain referred to in the present invention is a new application mode of computer technologies such as distributed data storage, point-to-point transmission, a consensus mechanism and an encryption algorithm. Blockchain, essentially a decentralized database, is a series of data blocks associated by cryptography. Each data block contains a batch of information of network transactions, which is configured for verifying the validity (anti-counterfeiting) of its information and generating the next block. The blockchain may include an underlying platform of blockchain, a platform product service layer, and an application service layer.

In addition, it is obvious that the word “include” does not exclude other elements or steps, and the singular does not exclude the plural. A plurality of units or devices stated in the system claims can also be realized by one unit or device through software or hardware. The second-class words are used to indicate names, but do not indicate any particular order.

Finally, it should be noted that the above embodiments are only used to illustrate the technical scheme of the present invention, but not to limit it. Although the present invention has been described in detail with reference to the preferred embodiments, those skilled in the art should understand that the technical scheme of the present invention may be modified or replaced by equivalents without departing from the spirit and scope of the technical scheme of the present invention.

What is claimed is:

1. A method for entity relationship recognition, the method comprising:
acquiring a to-be-recognized text and target entity types requiring entity relationship recognition, and performing sentence segmentation on the to-be-recognized text to obtain one or more statement texts;
performing entity recognition on the statement text, and performing entity type screening on all statement texts based on an entity recognition result and the target entity types to obtain a target statement text;
replacing entities corresponding to the target entity types in the target statement text with a predetermined identifier, and performing part-of-speech tagging and acceptation or rejection on a replaced target statement text to obtain a to-be-recognized fuzzy text;
acquiring all optional entity relationships among the entities of the target entity types and an entity relationship example sentence text corresponding to each of the optional entity relationships, replacing the entities of the target entity types in the entity relationship example sentence text with the predetermined identifier, and performing part-of-speech tagging and acceptation or rejection on a replaced entity relationship example sentence text to obtain a corresponding example sentence fuzzy text;
calculating a similarity between the to-be-recognized fuzzy text and the example sentence fuzzy text to obtain a text similarity; and
screening all entity relationship example sentences based on the text similarity, and determining the optional entity relationship corresponding to a screened entity relationship example sentence as an entity relationship recognition result of the to-be-recognized text.

2. The method for entity relationship recognition according to claim 1, wherein the performing sentence segmentation on the to-be-recognized text to obtain one or more statement texts comprises:
replacing all statement identifiers of a preset type contained in the to-be-recognized text with a preset segmentation symbol to obtain an initial to-be-segmented text;
adding the segmentation symbol before a first character of the initial to-be-segmented text to obtain a target to-be-segmented text; and
segmenting all characters between every two adjacent segmentation symbols in the target to-be-segmented text to obtain the statement text.

3. The method for entity relationship recognition according to claim 1, wherein the performing sentence segmentation on the to-be-recognized text to obtain one or more statement texts comprises:
judging whether a quantity of the statement identifier of a preset type contained in the to-be-recognized text is larger than 1;
when the quantity of the statement identifiers of the preset type contained in the to-be-recognized text is larger than 1, replacing all statement identifiers of the preset type contained in the to-be-recognized text with a preset segmentation symbol to obtain an initial to-be-segmented text;
adding the segmentation symbol before a first character of the initial to-be-segmented text to obtain a target to-be-segmented text;
segmenting all characters between every two adjacent segmentation symbols in the target to-be-segmented text to obtain the statement text; and
when the quantity of the statement identifiers of the preset type contained in the to-be-recognized text is smaller than or equal to 1, determining the to-be-recognized text as the statement text.

4. The method for entity relationship recognition according to claim 1, wherein the performing entity recognition on the statement text, and the performing entity type screening on all statement texts based on an entity recognition result and the target entity types to obtain a target statement text comprise:
recognizing entity types of all entities in the statement text; and
determining the statement text containing all the target entity types in all the recognized entity types as the target statement text.

5. The method for entity relationship recognition according to claim 1, wherein the replacing entities corresponding to the target entity types in the target statement text with a predetermined identifier and the performing part-of-speech tagging and acceptation or rejection on the replaced target statement text to obtain a to-be-recognized fuzzy text comprise:
determining entities corresponding to the target entity types in the target statement text as target words, and labeling the entity types of the entities in the target statement text;
determining a sentence trunk in the target statement text according to a dependency grammar tag, performing a grammar back-tracing operation on the target words not contained in the sentence trunk till determining that the target words are connected to a layer-by-layer correlation chain of the sentence trunk, and replacing a word not in the layer-by-layer correlation chain with a preset substitution identifier to obtain a first fuzzy text containing the sentence trunk;
replacing the target word in the first fuzzy text with a predetermined identifier to obtain a second fuzzy text;
reserving only the entity type of an entity of a non-target word in the second fuzzy text to obtain a third fuzzy text; and
reserving a non-entity word of a preset part-of-speech type in the third fuzzy text and corresponding part-of-speech information, and reserving part-of-speech information of the non-entity word of a non-preset type in the third fuzzy text to obtain the to-be-recognized fuzzy text.

6. The method for entity relationship recognition according to claim 1, wherein the calculating a similarity between the to-be-recognized fuzzy text and the example sentence fuzzy text to obtain a text similarity comprises:
transforming the to-be-recognized fuzzy text to a to-be-recognized fuzzy text vector, and transforming the example sentence fuzzy text to an example sentence fuzzy text vector; and
calculating a vector similarity between the to-be-recognized fuzzy text vector and the example sentence fuzzy text vector to obtain the text similarity.

7. The method for entity relationship recognition according to claim 1, wherein the screening all entity relationship example sentences based on the text similarity, and the determining the optional entity relationship corresponding to the screened entity relationship example sentence as an entity relationship recognition result of the to-be-recognized text comprise:
determining the example sentence fuzzy text corresponding to an example sentence fuzzy text vector corresponding to a maximum text similarity as a target example sentence fuzzy text;
determining the entity relationship example sentence corresponding to the target example sentence fuzzy text as a target entity relationship example sentence;
determining the optional entity relationship corresponding to the target entity relationship example sentence as the entity relationship recognition result in the target statement text; and
summarizing all entity relationship recognition results in the target statement text to obtain the entity relationship recognition result of the to-be-recognized text.

8. An electronic device, the electronic device comprising:
at least one processor; and
a memory in communication connection with the at least one processor;
wherein, the memory stores a computer program that can be executed by the at least one processor, and the computer program is executed by the at least one processor to enable the at least one processor to execute following steps:
acquiring a to-be-recognized text and target entity types requiring entity relationship recognition, and performing sentence segmentation on the to-be-recognized text to obtain one or more statement texts;
performing entity recognition on the statement text, and performing entity type screening on all statement texts based on an entity recognition result and the target entity types to obtain a target statement text;
replacing entities corresponding to the target entity types in the target statement text with a predetermined identifier, and performing part-of-speech tagging and acceptation or rejection on the replaced target statement text to obtain a to-be-recognized fuzzy text;
acquiring all optional entity relationships among the entities of the target entity types and an entity relationship example sentence text corresponding to each of the optional entity relationships, replacing the entities of the target entity types in the entity relationship example sentence text with the predetermined identifier, and performing part-of-speech tagging and acceptation or rejection on the replaced entity relationship example sentence text to obtain a corresponding example sentence fuzzy text;
calculating a similarity between the to-be-recognized fuzzy text and the example sentence fuzzy text to obtain a text similarity; and
screening all entity relationship example sentences based on the text similarity, and determining the optional entity relationship corresponding to the screened entity relationship example sentence as an entity relationship recognition result of the to-be-recognized text.

9. The electronic device according to claim 8, wherein the performing sentence segmentation on the to-be-recognized text to obtain one or more statement texts comprises:
replacing all statement identifiers of preset types contained in the to-be-recognized text with a preset segmentation symbol to obtain an initial to-be-segmented text;
adding the segmentation symbol before a first character of the initial to-be-segmented text to obtain a target to-be-segmented text; and
segmenting all characters between every two adjacent segmentation symbols in the target to-be-segmented text to obtain the statement text.

10. The electronic device according to claim 8, wherein the performing sentence segmentation on the to-be-recognized text to obtain one or more statement texts comprises:
judging whether a quantity of the statement identifier of a preset type contained in the to-be-recognized text is larger than 1;
when the quantity of the statement identifier of a preset type contained in the to-be-recognized text is larger than 1, replacing all statement identifiers of preset types contained in the to-be-recognized text with a preset segmentation symbol to obtain an initial to-be-segmented text;
adding the segmentation symbol before a first character of the initial to-be-segmented text to obtain a target to-be-segmented text;
segmenting all characters between every two adjacent segmentation symbols in the target to-be-segmented text to obtain the statement text; and
when the quantity of the statement identifier of a preset type contained in the to-be-recognized text is smaller than or equal to 1, determining the to-be-recognized text as the statement text.

11. The electronic device according to claim 8, wherein the performing entity recognition on the statement text, and the performing entity type screening on all statement texts based on an entity recognition result and the target entity types to obtain a target statement text comprise:
recognizing entity types of all entities in the statement text; and
determining the statement text containing all the target entity types in all the recognized entity types as the target statement text.

12. The electronic device according to claim 8, wherein the replacing entities corresponding to the target entity types in the target statement text with a predetermined identifier, and the performing part-of-speech tagging and acceptation or rejection on the replaced target statement text to obtain a to-be-recognized fuzzy text comprise:
determining the entities corresponding to the target entity types in the target statement text as target words, and labeling the entity types of the entities in the target statement text;
determining a sentence trunk in the target statement text according to a dependency grammar tag, performing a grammar back-tracing operation on the target words not contained in the sentence trunk till determining that the target words are connected to a layer-by-layer correlation chain of the sentence trunk, and replacing a word not in the layer-by-layer correlation chain with a preset substitution identifier to obtain a first fuzzy text containing the sentence trunk;
replacing the target word in the first fuzzy text with a predetermined identifier to obtain a second fuzzy text;
reserving only the entity type of an entity of a non-target word in the second fuzzy text to obtain a third fuzzy text; and
reserving a non-entity word of a preset part-of-speech type in the third fuzzy text and corresponding part-of-speech information, and reserving part-of-speech information of the non-entity word of a non-preset type in the third fuzzy text to obtain the to-be-recognized fuzzy text.

13. The electronic device according to claim 8, wherein the calculating a similarity between the to-be-recognized fuzzy text and the example sentence fuzzy text to obtain a text similarity comprises:
transforming the to-be-recognized fuzzy text to a to-be-recognized fuzzy text vector, and transforming the example sentence fuzzy text to an example sentence fuzzy text vector; and
calculating a vector similarity between the to-be-recognized fuzzy text vector and the example sentence fuzzy text vector to obtain the text similarity.

14. The electronic device according to claim 8, wherein the screening all entity relationship example sentences based on the text similarity, and the determining the optional entity relationship corresponding to the screened entity relationship example sentence as an entity relationship recognition result of the to-be-recognized text comprise:
determining the example sentence fuzzy text corresponding to an example sentence fuzzy text vector corresponding to a maximum text similarity as the target example sentence fuzzy text;
determining the entity relationship example sentence corresponding to the target example sentence fuzzy text as the target entity relationship example sentence;
determining the optional entity relationship corresponding to the target entity relationship example sentence as the entity relationship recognition result in the target statement text; and
summarizing all entity relationship recognition results in the target statement text to obtain the entity relationship recognition result of the to-be-recognized text.

15. A non-volatile computer readable storage medium storing a computer program, the computer program implementing following steps when being executed by a processor:
acquiring a to-be-recognized text and target entity types requiring entity relationship recognition, performing sentence segmentation on the to-be-recognized text to obtain one or more statement texts;
performing entity recognition on the statement text, and performing entity type screening on all statement texts based on an entity recognition result and the target entity types to obtain a target statement text;
replacing entities corresponding to the target entity types in the target statement text with a predetermined identifier, performing part-of-speech tagging and acceptation or rejection on the replaced target statement text to obtain a to-be-recognized fuzzy text;
acquiring all optional entity relationships among the entities of the target entity types and an entity relationship example sentence text corresponding to each of the optional entity relationships, replacing the entities of the target entity types in the entity relationship example sentence text with the predetermined identifier, performing part-of-speech tagging and acceptation or rejection on the replaced entity relationship example sentence text to obtain a corresponding example sentence fuzzy text;
calculating a similarity between the to-be-recognized fuzzy text and the example sentence fuzzy text to obtain a text similarity; and
screening all entity relationship example sentences based on the text similarity, and determining the optional entity relationship corresponding to the screened entity relationship example sentence as an entity relationship recognition result of the to-be-recognized text.

16. The non-volatile computer readable storage medium according to claim 15, wherein the performing sentence segmentation on the to-be-recognized text to obtain one or more statement texts comprises:
replacing all statement identifiers of preset types contained in the to-be-recognized text with a preset segmentation symbol to obtain an initial to-be-segmented text;
adding the segmentation symbol before a first character of the initial to-be-segmented text to obtain a target to-be-segmented text; and
segmenting all characters between every two adjacent segmentation symbols in the target to-be-segmented text to obtain the statement text.

17. The non-volatile computer readable storage medium according to claim 15, wherein the performing entity recognition on the statement text, and the performing entity type screening on all statement texts based on an entity recognition result and the target entity types to obtain a target statement text comprise:
recognizing entity types of all entities in the statement text; and
determining the statement text containing all the target entity types in all the recognized entity types as the target statement text.

18. The non-volatile computer readable storage medium according to claim 15, wherein the replacing entities corresponding to the target entity types in the target statement text with a predetermined identifier, and performing part-of-speech tagging and acceptation or rejection on the replaced target statement text to obtain a to-be-recognized fuzzy text comprise:
determining the entities corresponding to the target entity types in the target statement text as target words, and labeling the entity types of the entities in the target statement text;
determining a sentence trunk in the target statement text according to a dependency grammar tag, performing a grammar back-tracing operation on the target words not contained in the sentence trunk till determining that the target words are connected to a layer-by-layer correlation chain of the sentence trunk, and replacing a word not in the layer-by-layer correlation chain with a preset substitution identifier to obtain a first fuzzy text containing the sentence trunk;
replacing the target word in the first fuzzy text with a predetermined identifier to obtain a second fuzzy text;
reserving only the entity type of an entity of a non-target word in the second fuzzy text to obtain a third fuzzy text; and
reserving a non-entity word of a preset part-of-speech type in the third fuzzy text and corresponding part-of-speech information, and reserving part-of-speech information of the non-entity word of a non-preset type in the third fuzzy text to obtain the to-be-recognized fuzzy text.

19. The non-volatile computer readable storage medium according to claim 15, wherein the calculating a similarity between the to-be-recognized fuzzy text and the example sentence fuzzy text to obtain a text similarity comprises:
transforming the to-be-recognized fuzzy text to a to-be-recognized fuzzy text vector, and transforming the example sentence fuzzy text to an example sentence fuzzy text vector; and
calculating a vector similarity between the to-be-recognized fuzzy text vector and the example sentence fuzzy text vector to obtain the text similarity.

20. The non-volatile computer readable storage medium according to claim 15, wherein the screening all entity relationship example sentences based on the text similarity, and the determining the optional entity relationship corresponding to the screened entity relationship example sentence as an entity relationship recognition result of the to-be-recognized text comprise:
determining the example sentence fuzzy text corresponding to an example sentence fuzzy text vector corresponding to a maximum text similarity as the target example sentence fuzzy text;
determining the entity relationship example sentence corresponding to the target example sentence fuzzy text as the target entity relationship example sentence;
determining the optional entity relationship corresponding to the target entity relationship example sentence as the entity relationship recognition result in the target statement text; and
summarizing all entity relationship recognition results in the target statement text to obtain the entity relationship recognition result of the to-be-recognized text.
